(19) United States
(12) Patent Application Publication
(10) Pub. No.: US 2026/0235056 A1
(43) Pub. Date: Aug. 13, 2026

(54) SYSTEM AND CONTROL METHOD

(71) Applicant: KOMATSU LTD., Tokyo (JP)

(72) Inventor: Keisuke Goma, Tokyo (JP)

(73) Assignee: KOMATSU LTD., Tokyo (JP)

(21) Appl. No.: 19/153,362

(22) PCT Filed: Jan. 29, 2024
(86) PCT No.: PCT/JP2024/002670

§ 371 Date: Aug. 4, 2025

(30) Foreign Application Priority Data
Feb. 17, 2023 (JP) 2023-023422

(51) Int. Cl. F01M 13/00; F01M 11/10; F01M 13/02; F02B 43/10; F02M 35/10

(52) U.S. Cl. CPC F01M 13/0011; F01M 11/10; F01M 13/028; F02B 43/10; F02M 35/10222

(57) ABSTRACT

A system including an engine operable with a fuel containing hydrogen includes: a crankcase of the engine; an engine intake passage through which air is suctioned into the engine; a crankcase intake passage that branches from the engine intake passage and through which the air is introduced into the crankcase; a dilution air valve disposed in the crankcase intake passage and configured to open and close the crankcase intake passage; a compressor disposed upstream of a branch portion at which the crankcase intake passage branches from the engine intake passage; a hydrogen sensor configured to detect hydrogen concentration inside the crankcase; a crankcase exhaust passage through which the air inside the crankcase is discharged; and a control device configured to control opening and closing of the dilution air valve based on the hydrogen concentration detected by the hydrogen sensor.

### TECHNICAL FIELD

The present disclosure relates to a system and a control method.

The present disclosure claims priority based on Japanese Patent Application No. 2023-023422, filed on Feb. 17, 2023, the content of which is incorporated herein by reference.

### BACKGROUND ART

In an engine, gas in a combustion chamber may leak into a crankcase through a space between a cylinder and a piston. The leaking gas is called blow-by gas. Some engines can be operated with a fuel containing hydrogen. Hydrogen gas has a very wide combustible range compared to other fuels such as natural gas and gasoline, and ignites even when diluted to 10 times the theoretical air fuel ratio. Therefore, in the engine using a fuel containing hydrogen, the concentration of hydrogen gas is possibly maintained enough to be ignitable inside the crankcase. As a result, in the engine operable with a fuel containing hydrogen, hydrogen gas needs to be prevented from igniting inside the crankcase.

For example, Patent Document 1 discloses a four-stroke engine operable with a fuel containing hydrogen gas. The engine includes a crankcase in which a ventilating opening is formed, a ventilation flow path connecting the outside of the crankcase and the ventilating opening, and a ventilation fan disposed in the ventilation flow path. The ventilation fan forcibly discharges hydrogen gas in such an amount that the hydrogen gas concentration inside the crankcase is below a lower limit of the combustible range, from the inside of the crankcase to the outside together with gas other than hydrogen gas.

### CITATION LIST

### Patent Literature

Patent Document 1: JP 2021-127704 A

### SUMMARY OF INVENTION

### Technical Problem

However, a ventilation fan needs to be newly installed, which may highly cause deterioration in cost-effectiveness and reliability. Therefore, there is room for improvement in suppressing deterioration in cost-effectiveness and reliability.

The present disclosure is thus intended to provide a system and a control method that can prevent hydrogen gas from igniting inside a crankcase and suppress deterioration in cost-effectiveness and reliability.

### Solution to Problem

A system according to one aspect of the present disclosure is a system including an engine operable with a fuel containing hydrogen, the system including: a crankcase of the engine;
an engine intake passage through which air is suctioned into the engine; a crankcase intake passage that branches from the engine intake passage and through which the air is introduced into the crankcase; a dilution air valve disposed in the crankcase intake passage and configured to open and close the crankcase intake passage; a compressor disposed upstream of a branch portion at which the crankcase intake passage branches from the engine intake passage; a hydrogen sensor configured to detect hydrogen concentration inside the crankcase; a crankcase exhaust passage through which the air inside the crankcase is discharged; and a control device configured to control opening and closing of the dilution air valve based on the hydrogen concentration detected by the hydrogen sensor.

### Advantageous Effects of Invention

According to the above aspect, hydrogen gas can be prevented from igniting inside the crankcase and deterioration in cost-effectiveness and reliability can be suppressed.

### BRIEF DESCRIPTION OF DRAWINGS

FIG. 1 is a schematic configuration diagram of a system according to a first embodiment.

FIG. 2 is a flowchart of an example of a control method for the system according to the first embodiment.

FIG. 3 is a schematic configuration diagram of a system according to a second embodiment.

FIG. 4 is a flowchart of an example of a control method for the system according to the second embodiment.

### DESCRIPTION OF EMBODIMENTS

Hereinafter, embodiments of the present disclosure will be described with reference to the drawings. In the embodiments, a hydrogen engine (an example of an engine operable with a fuel containing hydrogen) will be described as an engine constituting the system.

### First Embodiment

### System

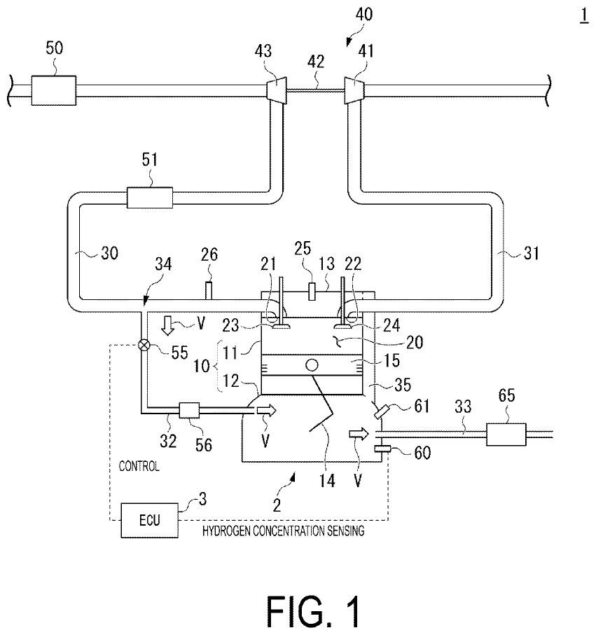

FIG. 1 is a schematic configuration diagram of a system 1 according to a first embodiment.

As illustrated in FIG. 1, the system 1 includes a hydrogen engine 2 (hereinafter, also simply referred to as “engine 2 ”). For example, the engine 2 may be operable with a fuel containing hydrogen and may be operable with a fuel not containing hydrogen. Note that the fuel containing hydrogen includes a fuel in which a part of the fuel is hydrogen gas and a fuel in which the entire fuel is hydrogen gas (that is, hydrogen gas itself). The use of the engine 2 is not particularly limited, and the engine 2 may be used for driving a vehicle or the like or for power generation. For example, the use of the engine 2 can be changed according to the design specifications.

The engine 2 includes a cylinder block 10 including a cylinder 11 and a crankcase 12, a cylinder head 13 located above the cylinder block 10, and a piston 15 configured to reciprocate inside the cylinder 11 and drive a crankshaft (not illustrated) via a connecting rod 14.

The engine 2 includes a combustion chamber 20 defined by an inner peripheral surface of the cylinder 11, an upper surface of the piston 15, and a lower surface of the cylinder head 13. In the cylinder head 13, an intake port 21 and an exhaust port 22 that open to the combustion chamber 20 are formed. The cylinder head 13 is provided with an intake valve 23 configured to open and close a portion of the intake port 21, which opens to the combustion chamber 20; and an exhaust valve 24 configured to open and close a portion of the exhaust port 22, which opens to the combustion chamber 20. The cylinder head 13 may be provided with an ignition device 25 configured to ignite a fuel in the combustion chamber 20.

The engine 2 may be provided with a hydrogen injection device 26 configured to inject hydrogen as the fuel into the combustion chamber 20. In the example of the drawing, the hydrogen injection device 26 is disposed in an engine intake passage 30, but is not limited thereto. For example, the hydrogen injection device 26 may be disposed in the cylinder head 13. The hydrogen injection device 26 may be disposed in the cylinder head 13, and a diesel or gasoline injection device may be disposed in the cylinder head 13. For example, the installation location of the hydrogen injection device 26 and combination thereof with another injection device can be changed according to the design specifications.

The system 1 includes the engine intake passage 30 through which air is sucked into the engine 2, and an engine exhaust passage 31 through which exhaust gas is discharged from the engine 2. The engine intake passage 30 is connected to the intake port 21. The engine exhaust passage 31 is connected to the exhaust port 22.

The system 1 includes a crankcase intake passage 32 that branches from the engine intake passage 30 and through which the air is introduced into the crankcase 12, and a crankcase exhaust passage 33 through which the air inside the crankcase 12 is discharged. The crankcase intake passage 32 is connected to a portion of the crankcase 12 on the intake port 21 side. The crankcase exhaust passage 33 is connected to a portion of the crankcase 12 on the exhaust port 22 side (a portion on the opposite side from a connection portion of the crankcase intake passage 32). Note that the connection locations of the crankcase intake passage 32 and the crankcase exhaust passage 33 are not limited to the above locations and can be changed according to design specifications.

The system 1 includes a turbocharger 40 configured to increase density of the air sucked by the engine 2. This allows more oxygen to be fed to the combustion chamber 20, and higher combustion energy can be obtained. The turbocharger 40 includes a turbine 41 configured to rotate by receiving the flow of exhaust gas, a shaft 42 via which rotational force of the turbine 41 is transmitted, and a compressor 43 configured to take in and compress air by the rotational force transmitted via the shaft 42.

For example, the turbine 41 and the compressor 43 are coupled to each other via the shaft 42 so as to be integrally rotatable. The turbine 41 is disposed in the engine exhaust passage 31.

The compressor 43 is disposed in the engine intake passage 30. The compressor 43 is disposed upstream of a branch portion 34 at which the crankcase intake passage 32 branches from the engine intake passage 30. Intake air flowing through the engine intake passage 30 is pressure fed by the compressor 43, and thus the intake air is forcibly fed into the combustion chamber 20 of the engine 2.

The engine intake passage 30 is provided with an air cleaner 50 configured to filter the intake air, the compressor 43, and an aftercooler 51 configured to lower the temperature of the intake air by heat exchange with the atmosphere, in the mentioned order from the upstream side in the intake air flow direction. In the engine intake passage 30, although not illustrated, an intake throttle configured to open and close the engine intake passage 30 may be disposed downstream of the aftercooler 51 and upstream of the branch portion 34. Note that the intake throttle functions as a throttle valve configured to variably set the passage cross-sectional area of the engine intake passage 30.

The system 1 includes a communication path 35 that allows the inside of the crankcase 12 to communicate with the inside of the cylinder head 13. For example, the communication path 35 may be a passage (for example, an oil return hole) for oil (for example, lubricating oil) flowing for driving a valve system of the cylinder head 13. In the example of the drawing, the communication path 35 extends vertically on a side part of the cylinder head 13. The communication path 35 is connected to a portion of the cylinder head 13 on the exhaust port 22 side and a portion of the crankcase 12 on the exhaust port 22 side. Note that the connection locations of the communication path 35 are not limited to the above locations and can be changed according to design specifications.

The system 1 includes a dilution air valve 55 disposed in the crankcase intake passage 32 and configured to open and close the crankcase intake passage 32. The dilution air valve 55 functions as a throttle valve configured to variably set the passage cross-sectional area of the crankcase intake passage 32. The dilution air valve 55 and a decompression valve 56 configured to reduce pressure of the intake air flowing through the crankcase intake passage 32 to a predetermined pressure or lower are disposed in the crankcase intake passage 32 in the mentioned order from the upstream side in the intake air flow direction.

The system 1 includes a hydrogen sensor 60 configured to detect hydrogen concentration inside the crankcase 12. In the example of the drawing, the hydrogen sensor 60 is disposed near a lower part of a portion of the crankcase 12 to which the crankcase exhaust passage 33 is connected. Note that the installation location of the hydrogen sensor 60 is not limited to the above location and can be changed according to the design specifications.

The engine 2 repeats a cycle of an intake process, a compression process, a combustion expansion process, and an exhaust process. In the intake process, the combustion chamber 20 is filled with a mixed gas in which intake gas and fuel are mixed. A part of the mixed gas leaks into the crankcase 12 through a space between the cylinder 11 and the piston 15 mainly in the compression process and the combustion expansion process. When the fuel containing hydrogen is used, hydrogen gas enters the crankcase 12. The hydrogen sensor 60 detects the concentration of the hydrogen gas that has entered (hydrogen concentration inside the crankcase 12). A detection signal of the hydrogen sensor 60 (the detected hydrogen concentration) is sent to a control device 3 (ECU in the drawing).

The system 1 includes the control device 3 configured to control opening and closing of the dilution air valve 55 based on the hydrogen concentration detected by the hydrogen sensor 60. When the hydrogen concentration detected by the hydrogen sensor 60 reaches a threshold value or higher, the control device 3 performs control to open the dilution air valve 55 to a predetermined degree or more. Note that the control device 3 may integrally control the components of the system 1.

The system 1 may include a pressure relief valve 61 configured to release the air inside the crankcase 12 before the pressure inside the crankcase 12 reaches a predetermined pressure or higher. In the example of the drawing, the pressure relief valve 61 is disposed near an upper part of a portion of the crankcase 12 to which the crankcase exhaust passage 33 is connected. Note that the installation location of the pressure relief valve 61 is not limited to the above location and can be changed according to design specifications.

In the present embodiment, the crankcase exhaust passage 33 is exposed to the atmosphere. Accordingly, the air compressed in the compressor 43 can be directly introduced into the crankcase 12 and directly discharged through the crankcase exhaust passage 33. Note that the arrows V in the drawing indicate the flow of dilution air.

The system 1 includes a filter 65 disposed in the crankcase exhaust passage 33. The filter 65 filters exhaust gas. For example, the filter 65 removes (collects) components contained in the exhaust gas from the inside of the crankcase 12. The components contained in the exhaust gas include particulate matter (PM), hydrocarbons (HC), nitrogen oxides (NOx), carbon monoxide (CO), carbon dioxide (CO2), sulfur oxides (SOx), and the like. For example, the components contained in the exhaust gas include oil mist and the like.

### Example of Control Method for System

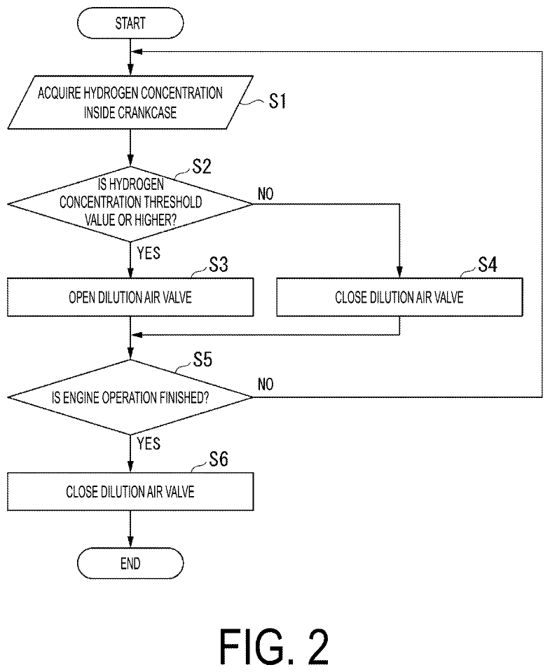

FIG. 2 is a flowchart of an example of a control method for the system 1 according to the first embodiment. The control method for the system 1 corresponds to an ignition prevention program to be executed by the control device 3.

The control method of the present embodiment includes a hydrogen concentration acquisition step (step S1) of acquiring the hydrogen concentration inside the crankcase 12, a hydrogen concentration determination step (step S2) of determining whether or not the hydrogen concentration is a threshold value or higher, a valve opening step (step S3) of opening the dilution air valve 55 when it is determined that the hydrogen concentration is the threshold value or higher, and a valve closing step (step S4) of closing the dilution air valve 55 when it is determined that the hydrogen concentration is lower than the threshold value.

Referring also to FIG. 2, first, the hydrogen concentration inside the crankcase 12 is acquired (step S1). For example, in step S1, the control device 3 acquires a detection signal of the hydrogen sensor 60 (the detected hydrogen concentration). After step S1, the program proceeds to step S2.

In step S2, the control device 3 determines whether or not the hydrogen concentration is the threshold value or higher. The threshold value is set to a lower limit value of the combustible range of hydrogen gas. Note that the threshold value may be set to a value lower than the lower limit value of hydrogen gas by a predetermined amount.

For example, the combustible range of hydrogen gas in the air is about 4vol % or more and 75vol % or less. Therefore, when the inside of the crankcase 12 is filled with hydrogen gas and air, the lower limit value of the variable range is 4vol %. In this case, the threshold value is set to 4vol %. Note that the threshold value may be set with a certain margin to a value (for example, 3vol %) lower than 4vol %.

When it is determined that the hydrogen concentration is the threshold value or higher (YES in step S2), the program proceeds to step S3. When it is determined that the hydrogen concentration is the threshold value or higher, hydrogen gas is likely to ignite inside the crankcase 12.

On the other hand, when it is determined that the hydrogen concentration is not the threshold value or higher (that is, when it is determined that the hydrogen concentration is lower than the threshold value) (NO in step S2), the program proceeds to step S4.

In step S3, the dilution air valve 55 is opened. For example, in step S3, the control device 3 performs control to open the dilution air valve 55 to a predetermined degree or more. After step S3, the program proceeds to step S5.

In step S4, the dilution air valve 55 is closed. For example, in step S4, the control device 3 performs control to completely close the dilution air valve 55. After step S4, the program proceeds to step S5.

In step S5, the control device 3 determines whether the operation of the engine 2 is finished. When it is determined that the operation of the engine 2 is finished (YES in step S5), the program proceeds to step S6. On the other hand, when it is determined that the operation of the engine 2 is not finished (NO in step S5), the program returns to step S1, and steps S1 to S5 are repeated until the operation of the engine 2 is finished.

In step S6, the dilution air valve 55 is closed. For example, in step S6, the control device 3 performs control to completely close the dilution air valve 55.

As described above, the flow of the control method for the system 1 ends.

### Actions and Effects

As described above, the system 1 of the present embodiment is a system 1 including the engine 2 operable with a fuel containing hydrogen. The system 1 includes the crankcase 12 of the engine 2, the engine intake passage 30 through which air is suctioned into the engine 2, the crankcase intake passage 32 that branches from the engine intake passage 30 and through which the air is introduced into the crankcase 12, the dilution air valve 55 disposed in the crankcase intake passage 32 and configured to open and close the crankcase intake passage 32, the compressor 43 disposed upstream of the branch portion 34 branching from the engine intake passage 30 to the crankcase intake passage 32, the hydrogen sensor 60 configured to detect hydrogen concentration inside the crankcase 12, the crankcase exhaust passage 33 through which the air inside the crankcase 12 is discharged, and the control device 3 configured to control opening and closing of the dilution air valve 55 based on the hydrogen concentration detected by the hydrogen sensor 60.

According to this configuration, the opening and closing of the dilution air valve 55 can be controlled based on the hydrogen concentration detected by the hydrogen sensor 60 while the air compressed in the compressor 43 is introduced into the crankcase 12. Accordingly, the hydrogen concentration inside the crankcase 12 can be adjusted. In addition, since the air compressed in the compressor 43 is used, a suction fan or the like is not required, and the existing engine 2 can be configured with a minimum number of additional components.

Therefore, the possibility of deterioration in cost-effectiveness and reliability is low. As a result, this can prevent hydrogen gas from igniting inside the crankcase 12 and suppress deterioration in cost-effectiveness and reliability.

In addition, ventilation of blow-by gas is intermittently performed by operating the dilution air valve 55 by sensing the hydrogen concentration inside the crankcase 12. Therefore, only the minimum amount of dilution air is required.

In the present embodiment, the control device 3 performs control to open the dilution air valve 55 to a predetermined degree or more when the hydrogen concentration detected by the hydrogen sensor 60 reaches the threshold value or higher.

According to this configuration, the dilution air valve 55 can be opened to a predetermined degree or more when the hydrogen concentration detected by the hydrogen sensor 60 reaches the threshold value or higher while the air compressed in the compressor 43 is introduced into the crankcase 12. Accordingly, the hydrogen concentration inside the crankcase 12 can be out of the combustible range. Therefore, hydrogen gas can be more reliably prevented from igniting inside the crankcase 12.

In the present embodiment, the crankcase exhaust passage 33 is exposed to the atmosphere.

According to this configuration, the air compressed in the compressor 43 can be directly introduced into the crankcase 12 in which the blow-by gas exists and directly discharged through the crankcase exhaust passage 33. Therefore, the blow-by gas inside the crankcase 12 can be efficiently diluted.

In the present embodiment, the system 1 further includes the filter 65 disposed in the crankcase exhaust passage 33.

According to this configuration, the exhaust gas from the crankcase exhaust passage 33 can be purified by the filter 65.

In the present embodiment, the control method includes the hydrogen concentration acquisition step (step S1) of acquiring the hydrogen concentration inside the crankcase 12, the hydrogen concentration determination step (step S2) of determining whether or not the hydrogen concentration is the threshold value or higher, the valve opening step (step S3) of opening the dilution air valve 55 when it is determined that the hydrogen concentration is the threshold value or higher, and the valve closing step (step S4) of closing the dilution air valve 55 when it is determined that the hydrogen concentration is lower than the threshold value.

This method can prevent hydrogen gas from igniting inside the crankcase 12 and suppress deterioration in cost-effectiveness and reliability.

In addition, by including the valve opening step and the valve closing step, ventilation of the blow-by gas becomes intermittent. Therefore, only the minimum amount of dilution air is required.

In addition, the valve opening step enables the hydrogen concentration inside the crankcase 12 to be out of the combustible range. Therefore, hydrogen gas can be more reliably prevented from igniting inside the crankcase 12.

### Second Embodiment

In the first embodiment, the example in which the crankcase exhaust passage 33 is exposed to the atmosphere is described. A second embodiment is different from the first embodiment in that the crankcase exhaust passage 33 is connected to the upstream side of the compressor 43. In the following description, configurations that are the same as those of the first embodiment are denoted by the same reference signs, and description of the configurations is omitted.

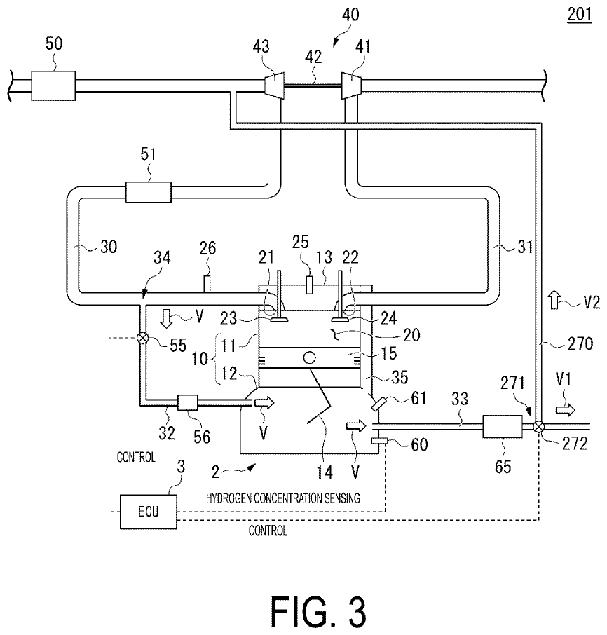

FIG. 3 is a schematic configuration diagram of a system 201 according to the second embodiment.

As illustrated in FIG. 3, the crankcase exhaust passage 33 is connected to the upstream side of the compressor 43. The system 201 includes a return passage 270 that branches from the crankcase exhaust passage 33 and through which the air inside the crankcase 12 is returned to the upstream side of the compressor 43. The return passage 270 is connected to the downstream side of the filter 65 in the crankcase exhaust passage 33 and to the downstream side of the air cleaner 50 and the upstream side of the compressor 43 in the engine intake passage 30.

The system 201 includes a switching valve 272 configured to switch between a first path V1 through which the crankcase exhaust passage 33 is exposed to the atmosphere and a second path V2 through which the crankcase exhaust passage 33 connects to the return passage 270. The switching valve 272 is disposed at a branch portion 271 at which the return passage 270 branches from the crankcase exhaust passage 33.

The control device 3 controls the switching valve 272 to switch to the second path V2 when the hydrogen concentration detected by the hydrogen sensor 60 reaches the threshold value or higher. The control device 3 controls the switching valve 272 to switch to the first path V1 when the hydrogen concentration detected by the hydrogen sensor 60 is not the threshold value or higher (that is, when the hydrogen concentration is lower than the threshold value).

### Example of Control Method for System

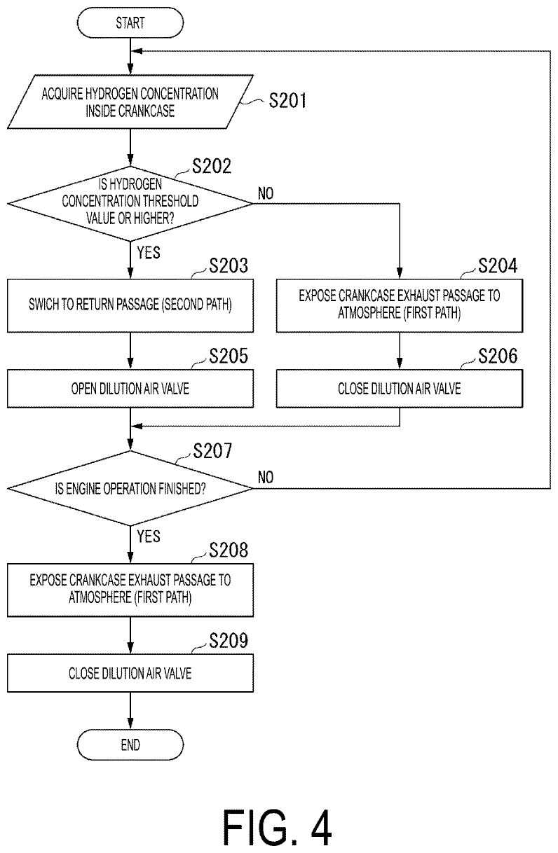

FIG. 4 is a flowchart of an example of a control method for the system 201 according to the second embodiment. The control method for the system 201 corresponds to an ignition prevention program to be executed by the control device 3.

The control method of the present embodiment includes a second path switching step (step S203) of allowing the switching valve 272 to switch to the second path V2 when it is determined that the hydrogen concentration is the threshold value or higher, and a first path switching step (step S204) of allowing the switching valve 272 to switch to the first path V1 when it is determined that the hydrogen concentration is lower than the threshold value.

Referring also to FIG. 4, first, the hydrogen concentration inside the crankcase 12 is acquired (step S201). For example, in step S201, the control device 3 acquires a detection signal of the hydrogen sensor 60 (the detected hydrogen concentration). After step S201, the program proceeds to step S202.

In step S202, the control device 3 determines whether or not the hydrogen concentration is the threshold value or higher. The threshold value is set to the lower limit (for example, 4vol %) of the combustible range of hydrogen gas. Note that the threshold value may be set to a value (for example, 3vol %) lower than the lower limit of hydrogen gas by a predetermined amount.

When it is determined that the hydrogen concentration is the threshold value or higher (YES in step S202), the program proceeds to step S203. On the other hand, when it is determined that the hydrogen concentration is not the threshold value or higher (that is, when it is determined that the hydrogen concentration is lower than the threshold value) (NO in step S202), the program proceeds to step S204.

In step S203, switching to the return passage 270 is performed (second path V2). For example, in step S203, the control device 3 controls the switching valve 272 to switch to the second path V2. As a result, the crankcase exhaust passage 33 connects to the return passage 270. After step S203, the program proceeds to step S205.

In step S205, the dilution air valve 55 is opened. For example, in step S205, the control device 3 performs control to open the dilution air valve 55 to a predetermined degree or more.

After step S205, the program proceeds to step S207.

On the other hand, in step S204, the crankcase exhaust passage 33 is exposed to the atmosphere (the first path V1). For example, in step S204, the control device 3 controls the switching valve 272 to switch to the first path V1. After step S204, the program proceeds to step S206.

In step S206, the dilution air valve 55 is closed. For example, in the step S206, the control device 3 performs control to completely close the dilution air valve 55. After step S206, the program proceeds to step S207.

In step S207, the control device 3 determines whether the operation of the engine 2 is finished. When it is determined that the operation of the engine 2 is finished (YES in step S207), the program proceeds to step S208. On the other hand, when it is determined that the operation of the engine 2 is not finished (NO in step S207), the program returns to step S201, and steps S201 to S207 are repeated until the operation of the engine 2 is finished.

In step S208, the crankcase exhaust passage 33 is exposed to the atmosphere (the first path V1). After step S208, the program proceeds to step S209.

In step S209, the dilution air valve 55 is closed. For example, in step S209, the control device 3 performs control to completely close the dilution air valve 55.

As described above, the flow of the control method for the system 201 ends.

### Actions and Effects

In the present embodiment, the crankcase exhaust passage 33 is connected to the upstream side of the compressor 43.

According to this configuration, the opening and closing of the dilution air valve 55 can be controlled based on the hydrogen concentration detected by the hydrogen sensor 60 while the exhaust air from the crankcase exhaust passage 33 is compressed in the compressor 43 and the compressed air is introduced into the crankcase 12. Accordingly, the hydrogen concentration inside the crankcase 12 can be adjusted. Therefore, a suction fan or the like is not required, and the existing engine 2 can be configured with a minimum number of additional components. As a result, this can prevent hydrogen gas from igniting inside the crankcase 12 and suppress deterioration in cost-effectiveness and reliability.

In the present embodiment, the system 201 further includes the return passage 270 that branches from the crankcase exhaust passage 33 and through which the air inside the crankcase 12 is returned to the upstream side of the compressor 43, and the switching valve 272 disposed at the branch portion 271 at which the return passage 270 branches from the crankcase exhaust passage 33 and configured to switch between the first path V1 through which the crankcase exhaust passage 33 is exposed to the atmosphere and the second path V2 through which the crankcase exhaust passage 33 connects to the return passage 270.

According to this configuration, the switching valve 272 can select whether to release the dilution air discharged from the crankcase 12 to the atmosphere (switching to the first path V1) or to return the dilution air to the upstream side of the compressor 43 (switching to the second path V2). Therefore, at the time of switching to the second path V2, the exhaust gas from the crankcase exhaust passage 33 does not flow to the outside. As a result, deterioration of exhaust gas emission can be minimized.

In the present embodiment, the control device 3 controls the switching valve 272 to switch to the second path V2 when the hydrogen concentration detected by the hydrogen sensor 60 reaches the threshold value or higher.

According to this configuration, when the hydrogen concentration detected by the hydrogen sensor 60 reaches the threshold value or higher, the air from the crankcase exhaust passage 33 and the return passage 270 (the second path V2) is compressed in the compressor 43, and the compressed air can be introduced into the crankcase 12. Therefore, when the hydrogen concentration detected by the hydrogen sensor 60 reaches the threshold value or higher, the exhaust gas from the crankcase exhaust passage 33 does not flow to the outside. As a result, deterioration of exhaust gas emission can be minimized.

In the present embodiment, the control method includes the second path switching step (step S203) of allowing the switching valve 272 to switch to the second path V2 when it is determined that the hydrogen concentration is the threshold value or higher, and the first path switching step (step S204) of allowing the switching valve 272 to switch to the first path V1 when it is determined that the hydrogen concentration is lower than the threshold value.

According to this method, by the second path switching step, the exhaust gas from the crankcase exhaust passage 33 does not flow to the outside. As a result, deterioration of exhaust gas emission can be minimized.

On the other hand, by the first path switching step, the exhaust gas from the crankcase 12 does not flow to the upstream side of the compressor 43. Therefore, the compressor 43 can be prevented from being contaminated by components or the like (for example, oil mist or the like) contained in the exhaust gas.

### Modification Example

In the embodiment described above, the example is described in which the system further includes the filter disposed in the crankcase exhaust passage, but the present disclosure is not limited thereto. For example, the system need not include a filter. For example, the installation mode of the filter can be changed according to the design specifications.

Although the embodiments of the present disclosure are described above, the present disclosure is not limited to these, and additions, omissions, substitutions, and other modifications of the configuration are possible without departing from the spirit of the present disclosure, and the embodiments described above can also be combined as appropriate.

### Supplementary Note 1

A system including an engine operable with a fuel containing hydrogen, the system including:
a crankcase of the engine;
an engine intake passage through which air is suctioned into the engine;
a crankcase intake passage that branches from the engine intake passage and through which the air is introduced into the crankcase;
a dilution air valve disposed in the crankcase intake passage and configured to open and close the crankcase intake passage;
a compressor disposed upstream of a branch portion at which the crankcase intake passage branches from the engine intake passage;
a hydrogen sensor configured to detect hydrogen concentration inside the crankcase;
a crankcase exhaust passage through which the air inside the crankcase is discharged; and
a control device configured to control opening and closing of the dilution air valve based on the hydrogen concentration detected by the hydrogen sensor.

### Supplementary Note 2

The system according to Supplementary Note 1, wherein when the hydrogen concentration detected by the hydrogen sensor reaches a threshold value or higher, the control device performs control to open the dilution air valve to a predetermined degree or more.

### Supplementary Note 3

The system according to Supplementary Note 1 or 2, wherein the crankcase exhaust passage is exposed to the atmosphere.

### Supplementary Note 4

The system according to any one of Supplementary Notes 1 to 3, wherein the crankcase exhaust passage is connected to an upstream side of the compressor.

### Supplementary Note 5

The system according to any one of Supplementary Notes 1 to 4, further including: a return passage that branches from the crankcase exhaust passage and through which the air inside the crankcase is returned to an upstream side of the compressor; and a switching valve disposed at a branch portion at which the return passage branches from the crankcase exhaust passage and configured to switch between a first path through which the crankcase exhaust passage is exposed to the atmosphere and a second path through which the crankcase exhaust passage connects to the return passage.

### Supplementary Note 6

The system according to Supplementary Note 5, wherein the control device is configured to control the switching valve to switch to the second path when the hydrogen concentration detected by the hydrogen sensor reaches a threshold value or higher.

### Supplementary Note 7

The system according to any one of Supplementary Notes 1 to 6, further including a filter disposed in the crankcase exhaust passage.

### Supplementary Note 8

A control method for a system including an engine operable with a fuel containing hydrogen,
the system including:
a crankcase of the engine;
an engine intake passage through which air is suctioned into the engine;
a crankcase intake passage that branches from the engine intake passage and through which the air is introduced into the crankcase;
a dilution air valve disposed in the crankcase intake passage and configured to open and close the crankcase intake passage;
a compressor disposed upstream of a branch portion at which the crankcase intake passage branches from the engine intake passage;
a hydrogen sensor configured to detect hydrogen concentration inside the crankcase; and
a crankcase exhaust passage through which the air inside the crankcase is discharged,
the control method including:
acquiring the hydrogen concentration inside the crankcase;
determining whether or not the hydrogen concentration is a threshold value or higher;
opening the dilution air valve when it is determined that the hydrogen concentration is the threshold value or higher; and
closing the dilution air valve when it is determined that the hydrogen concentration is lower than the threshold value.

### Supplementary Note 9

The control method according to Supplementary Note 8, wherein the system further includes:
a return passage that branches from the crankcase exhaust passage and through which the air inside the crankcase is returned to an upstream side of the compressor; and
a switching valve disposed at a branch portion at which the return passage branches from the crankcase exhaust passage and configured to switch between a first path through which the crankcase exhaust passage is exposed to the atmosphere and a second path through which the crankcase exhaust passage connects to the return passage, and
the control method includes:
allowing the switching valve to switch to the second path when it is determined that the hydrogen concentration is the threshold value or higher; and
allowing the switching valve to switch to the first path when it is determined that the hydrogen concentration is lower than the threshold value.

### Industrial Applicability

According to the above aspect, hydrogen gas can be prevented from igniting inside the crankcase and deterioration in cost-effectiveness and reliability can be suppressed.

### REFERENCE SIGNS LIST

1 System, 2 Engine, 3 Control device, 12 Crankcase, 30 Engine intake passage, 32 Crankcase intake passage, 33 Crankcase exhaust passage, 34 Branch portion at which crankcase intake passage branches from engine intake passage, 43 Compressor, 55 Dilution air valve, 60 Hydrogen sensor, 65 Filter, 201 System, 270 Return passage, 271 Branch portion at which return passage branches from crankcase exhaust passage, 272 Switching valve, V1 First path, V2 Second path

1. A system comprising an engine operable with a fuel containing hydrogen, the system comprising:
a crankcase of the engine;
an engine intake passage through which air is suctioned into the engine;
a crankcase intake passage that branches from the engine intake passage and through which the air is introduced into the crankcase;
a dilution air valve disposed in the crankcase intake passage and configured to open and close the crankcase intake passage;
a compressor disposed upstream of a branch portion at which the crankcase intake passage branches from the engine intake passage;
a hydrogen sensor configured to detect hydrogen concentration inside the crankcase;
a crankcase exhaust passage through which the air inside the crankcase is discharged; and
a control device configured to control opening and closing of the dilution air valve based on the hydrogen concentration detected by the hydrogen sensor.

2. The system according to claim 1, wherein when the hydrogen concentration detected by the hydrogen sensor reaches a threshold value or higher, the control device performs control to open the dilution air valve to a predetermined degree or more.

3. The system according to claim 1, wherein the crankcase exhaust passage is exposed to the atmosphere.

4. The system according to claim 1, wherein the crankcase exhaust passage is connected to an upstream side of the compressor.

5. The system according to claim 1, further comprising:
a return passage that branches from the crankcase exhaust passage and through which the air inside the crankcase is returned to an upstream side of the compressor; and
a switching valve disposed at a branch portion at which the return passage branches from the crankcase exhaust passage and configured to switch between a first path through which the crankcase exhaust passage is exposed to the atmosphere and a second path through which the crankcase exhaust passage connects to the return passage.

6. The system according to claim 5, wherein the control device is configured to control the switching valve to switch to the second path when the hydrogen concentration detected by the hydrogen sensor reaches a threshold value or higher.

7. The system according to claim 1, further comprising a filter disposed in the crankcase exhaust passage.

8. A control method for a system comprising an engine operable with a fuel containing hydrogen, the system comprising:
a crankcase of the engine;
an engine intake passage through which air is suctioned into the engine;
a crankcase intake passage that branches from the engine intake passage and through which the air is introduced into the crankcase;
a dilution air valve disposed in the crankcase intake passage and configured to open and close the crankcase intake passage;
a compressor disposed upstream of a branch portion at which the crankcase intake passage branches from the engine intake passage;
a hydrogen sensor configured to detect hydrogen concentration inside the crankcase; and
a crankcase exhaust passage through which the air inside the crankcase is discharged, the control method comprising:
acquiring the hydrogen concentration inside the crankcase;
determining whether or not the hydrogen concentration is a threshold value or higher;
opening the dilution air valve when it is determined that the hydrogen concentration is the threshold value or higher; and
closing the dilution air valve when it is determined that the hydrogen concentration is lower than the threshold value.

9. The control method according to claim 8, wherein the system further comprises:
a return passage that branches from the crankcase exhaust passage and through which the air inside the crankcase is returned to an upstream side of the compressor; and
a switching valve disposed at a branch portion at which the return passage branches from the crankcase exhaust passage and configured to switch between a first path through which the crankcase exhaust passage is exposed to the atmosphere and a second path through which the crankcase exhaust passage connects to the return passage, and
the control method comprises:
allowing the switching valve to switch to the second path when it is determined that the hydrogen concentration is the threshold value or higher; and
allowing the switching valve to switch to the first path when it is determined that the hydrogen concentration is lower than the threshold value.

10. The system according to claim 2, wherein the crankcase exhaust passage is exposed to the atmosphere.

11. The system according to claim 2, wherein the crankcase exhaust passage is connected to an upstream side of the compressor.

12. The system according to claim 2, further comprising:
a return passage that branches from the crankcase exhaust passage and through which the air inside the crankcase is returned to an upstream side of the compressor; and
a switching valve disposed at a branch portion at which the return passage branches from the crankcase exhaust passage and configured to switch between a first path through which the crankcase exhaust passage is exposed to the atmosphere and a second path through which the crankcase exhaust passage connects to the return passage.

13. The system according to claim 12, wherein the control device is configured to control the switching valve to switch to the second path when the hydrogen concentration detected by the hydrogen sensor reaches a threshold value or higher.

14. The system according to claim 2, further comprising a filter disposed in the crankcase exhaust passage.
